(19) United States
(12) Patent Application Publication
(10) Pub. No.: US 2022/0330752 A1
(43) Pub. Date: Oct. 20, 2022

(54) SPLATTER GUARD

(71) Applicant: Devaraj Thiruppathi, Columbus, GA (US)

(72) Inventor: Devaraj Thiruppathi, Columbus, GA (US)

(21) Appl. No.: 17/232,268

(22) Filed: Apr. 16, 2021

(51) Int. Cl. A47J 37/10

(52) U.S. Cl. CPC A47J 37/101

(57) ABSTRACT

A splatter guard for engagement with a pot or pan to prevent splatters of food and liquid on surfaces surrounding the pot or pan. The splatter guard includes a base that engage an upper edge of side wall of the pot or pan; an aperture defined by the base and aligns with an opening to an interior of the pot or pan; and a plurality of petals operatively engaged with the base. Each petal of the plurality of petals is pivotable relative to the base. The plurality of petals is selectively movable between a first position and a second position; and, when in the first position, the plurality of petals allows access to the interior of the pot or pan through the aperture defined by the base; and, when in the second position, the plurality of petals prevents access to the interior of the pot or pan through the aperture.

### TECHNICAL FIELD

This disclosure is directed to cooking equipment. More particularly, the disclosure relates to splatter guards which are engaged with a pot or pan to prevent droplets of liquid and small particles of food exiting the pot or pan from coming into contact with the stove and surrounding surfaces. Specifically, the present disclosure is directed to a splatter guard which is movable between a first position, where access to an interior of the pot or pan is enabled, and a second position where access to the interior of the pot or pan is prevented.

### BACKGROUND

### Background Information

Frying foods and rapidly boiling foods such as sauces, tend to create droplets of oil, water, or sauce that become airborne and exit the pot or pan in which the foods are being cooked. The droplets are carried away from the pot or pan and tend to settle on the stove and surrounding surfaces. This can make for a messy environment that later has to be cleaned.

To address this problem a number of splatter guards have been proposed in the prior art. One type of prior art splatter guard comprises a circular mesh screen with a handle. The splatter guard is positioned over the mouth of the pot or pan and the mesh screen is supposed to capture airborne droplets as they exit the pot or pan. This type of splatter guard prevents access to the cooking food and has to be lifted off the pot or pan in order to gain access to the food. An example of this type of splatter guard is the one disclosed in U.S. Pat. No. 4,258,694 (Kato). Kato discloses a pan with an integral spatter guard that is able to be temporarily lifted out of engagement with the pan to gain access to the food. A similar type of splatter guard is disclosed in U.S. Pat. No. 9,504,355 (Lee et al.). The Lee et al. splatter guard is able to be folded and thereby could be used with one portion in a folded position so that partial access may be gained to food cooking inside a pot or pan.

Another type of prior art splatter guard comprises a truncated conical sleeve that is engaged with the pot or pan. The narrowest end of the sleeve is placed proximate the rim of the pot or pan and the rest of the sleeve flares upwardly and outwardly away therefrom. The airborne droplets created by the cooking food are able to exit the mouth of the pot or pan and the cook has access to the cooking food. The idea behind these conical sleeves is that heavier droplets will tend to drop closest to the pot or pan. As the heavier droplets start to fall out of the air, they will tend to settle on the upwardly and outwardly flaring portion of the cone and will thereby be prevented from settling on the stove or other surfaces in the vicinity of the pot or pan. An example of this type of splatter guard is disclosed in U.S. Pat. No. 10,130,213 (Reiner). Reiner's splatter guard allows complete access to the cooking area of the pot or pan at all times. Riedl (U.S. Pat. No. 6,029,652) discloses an inverted conical splatter guard that defines a central opening through which it is possible to gain access to food cooking in a pot or pan. The central opening in the Riedl splatter guard is quite small and therefore quite impractical. Colwell et al. (U.S. Pat. No. 10,022,013) also discloses a splatter guard with a conical skirt and a central opening that permits access to cooking food. The central opening in the Colwell et al. device is larger and therefore more practical than the Riedl splatter guard.

### SUMMARY

The present inventor has recognized that it would be advantageous in some instances to be able to access food cooking in a pot or pan and in other instances to completely close off access to the cooking food. The splatter guard disclosed herein allows both of these advantages while additionally substantially reducing the number of droplets that will come to rest on the stove and surrounding surfaces. The presently disclosed splatter guard includes a plurality of overlapping petals that form a conical skirt that surround a central opening and enable access to food cooking in a pot or pan within which the splatter guard is engaged. The presently disclosed splatter guard may be moved to a closed position simply by applying light pressure to the petals to collapse them inwardly and close the central opening. When the splatter guard is in the closed position, it forms a lid that closes off access to the food cooking in the pot or pan. The presently disclosed splatter guard may readily be moved back to the first open position by simply applying a light pulling force on particular petals. This will cause all petals to fan outwardly to once again form the circular skirt that bounds the opening to the pot or pan.

In one aspect, an exemplary embodiment of the present disclosure may provide a splatter guard comprising a base adapted to engage a side wall of a pot or pan; an aperture defined by the base, said aperture being adapted to align with an opening to an interior of the pot or pan; and a plurality of petals operatively engaged with the base; wherein each petal of the plurality of petals is pivotable relative to the base; wherein the plurality of petals is selectively movable between a first position and a second position; and, when in the first position, the plurality of petals allows access to the interior of the pot or pan through the aperture defined by the base; and, when in the second position, the plurality of petals prevents access to the interior of the pot or pan through the aperture.

In another aspect, an exemplary embodiment of the present disclosure may provide a method of preventing liquid droplets and small particles of food from settling on surfaces surrounding a pot or pan in which foods is cooking, said method comprising providing a splatter guard including a base and a plurality of petals circumscribing an aperture defined by the base; engaging the base of the splatter guard with a side wall of the pot or pan; aligning the aperture defined by the base with an opening to an interior of the pot or pan; moving the plurality of petals to a first position when access to the interior of the pot or pan is desired; and moving the plurality of petals to a second position when access to the interior of the pot or pan is not desired.

In one embodiment, the method of using the splatter guard may further comprise creating a truncated conical skirt with the plurality of petals when moved to the first position; wherein the truncated conical skirt flares upwardly and outwardly away from the base; and capturing liquid droplets and small particles of food entrained in hot air exiting the interior of the pot or pan on the truncated conical skirt; and preventing the captured liquid droplets and small particles of food from contacting a surface beneath the conical skirt. In one embodiment, the method may further comprise creating a convex dome over the aperture defined by the base with the plurality of petals when moved to the second position; and preventing liquid droplets and small particles of food entrained in hot air in the interior of the pot or pan from moving past the convex dome. In one embodiment, the method may further comprise providing at least one actuating petal amongst the plurality of petals; and moving the plurality of petals between the first position and the second position by manipulating the at least one actuating petal. In one embodiment, the method may further comprise providing a handle on the base; and manipulating the splatter guard by way of the handle.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is top, isometric perspective view of a first embodiment of a splatter guard in accordance with an aspect of the present disclosure, where the splatter guard is engaged with a circular pot or pan, and is in a fully open position;

FIG. 2 is a top, isometric perspective view of the splatter guard of FIG. 1, moved to a first partially closed position;

FIG. 3 is a top, isometric perspective view of the splatter guard of FIG. 1 moved to a second partially closed position;

FIG. 4 is a top, isometric perspective view of the splatter guard of FIG. 1 moved to a fully closed position;

FIG. 5 is an exploded top, isometric perspective view of the splatter guard and the pot or pan, where the splatter guard is in the fully closed position;

FIG. 6 is a top, isometric perspective view of the splatter guard shown in isolation and showing the splatter guard in the second partially closed position as illustrated in FIG. 3;

FIG. 7 is a top, isometric perspective view of the annular base of the splatter guard shown in isolation;

FIG. 8 is a top, isometric perspective view of a single petal of the splatter guard shown in isolation;

FIG. 9 is a top, isometric perspective view of one of the two actuating petals shown in isolation;

FIG. 10A is a partial cross-section of the splatter guard engaged with a side wall of the pot or pan, with the splatter guard petal shown in the open position;

FIG. 10B is a partial cross-section of the splatter guard engaged with a side wall of the pot or pan as in FIG. 10A, with the splatter guard petal shown moved to a partially closed position;

FIG. 11A is an exploded top, isometric perspective view of a second embodiment of the splatter guard in accordance with the present disclosure that is configured for engagement with a square pot or pan, and where the splatter guard is illustrated in the partially closed position;

FIG. 11B is a top, isometric perspective view of the splatter guard of FIG. 11A engaged with the square pot or pan;

FIG. 11C is a partial cross-section of the splatter guard of FIG. 11B engaged with a side wall of the pot or pan; and

FIG. 12 is a top, isometric perspective view of the third embodiment of splatter guard in accordance with an aspect of the present disclosure shown in the second partially closed position.

Similar numbers refer to similar parts throughout the drawings.

### DETAILED DESCRIPTION

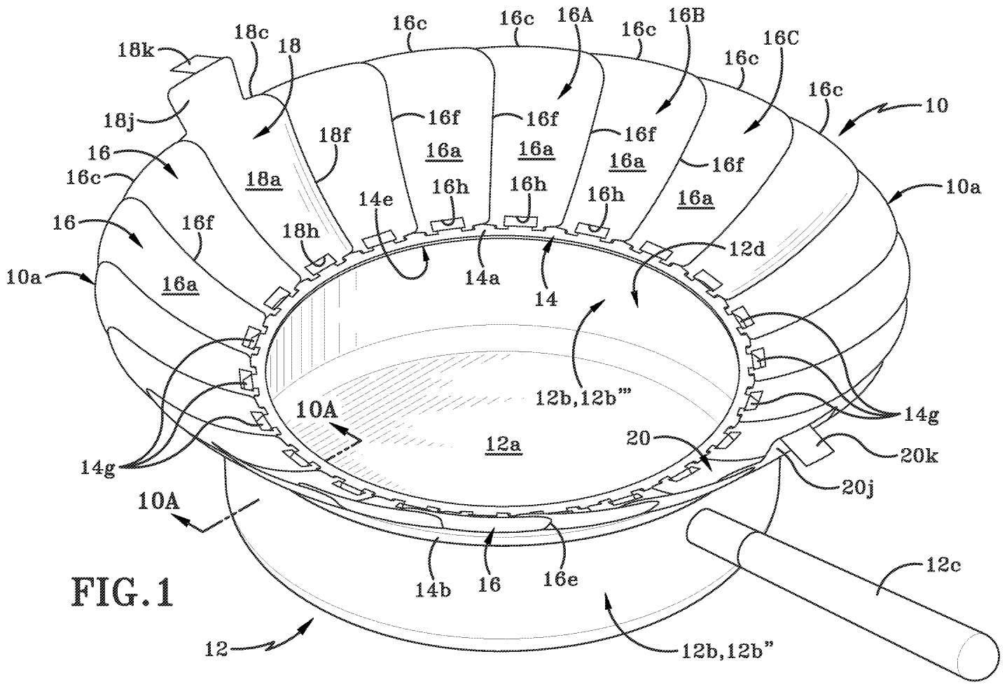

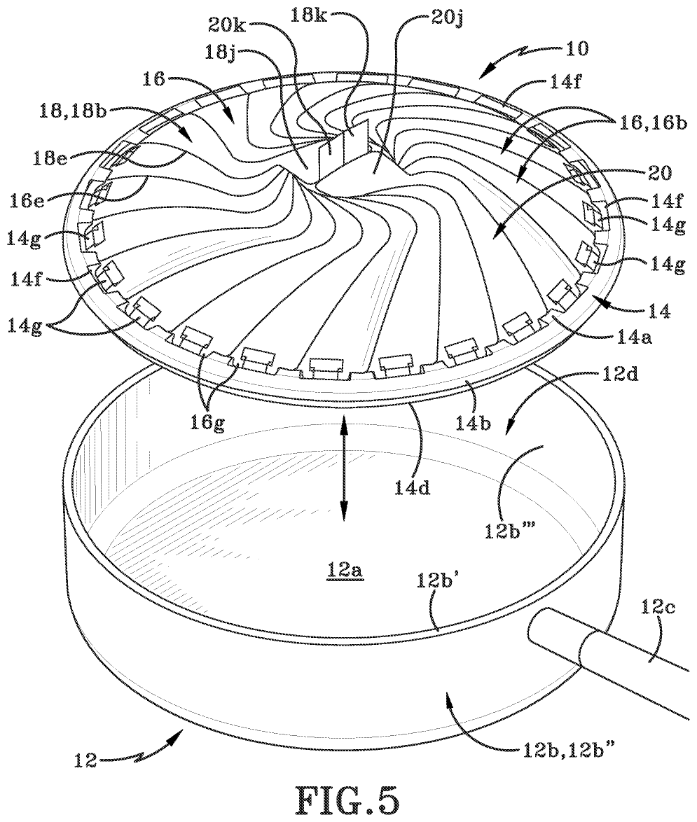

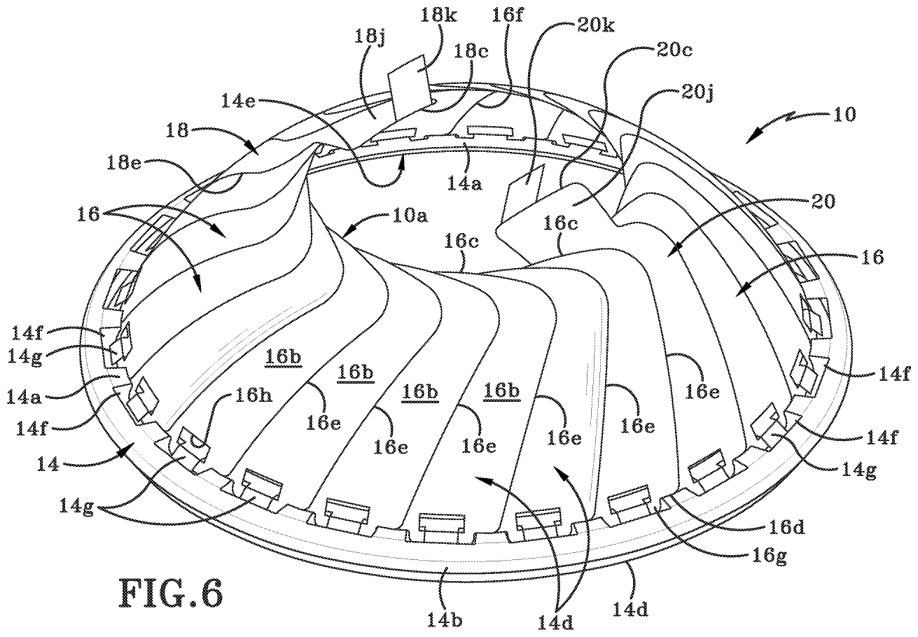

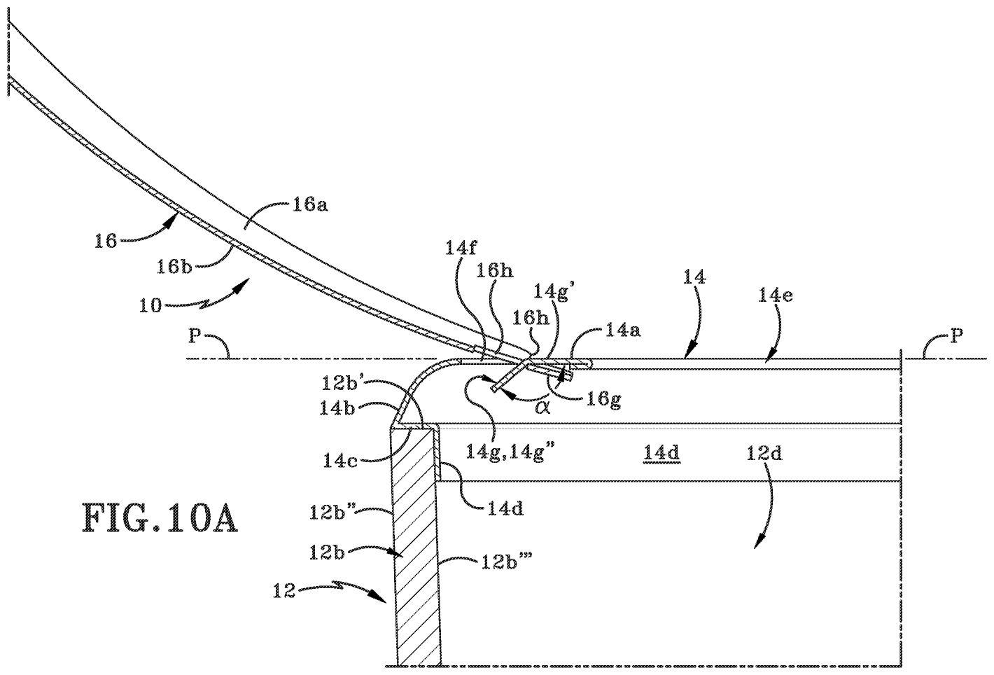

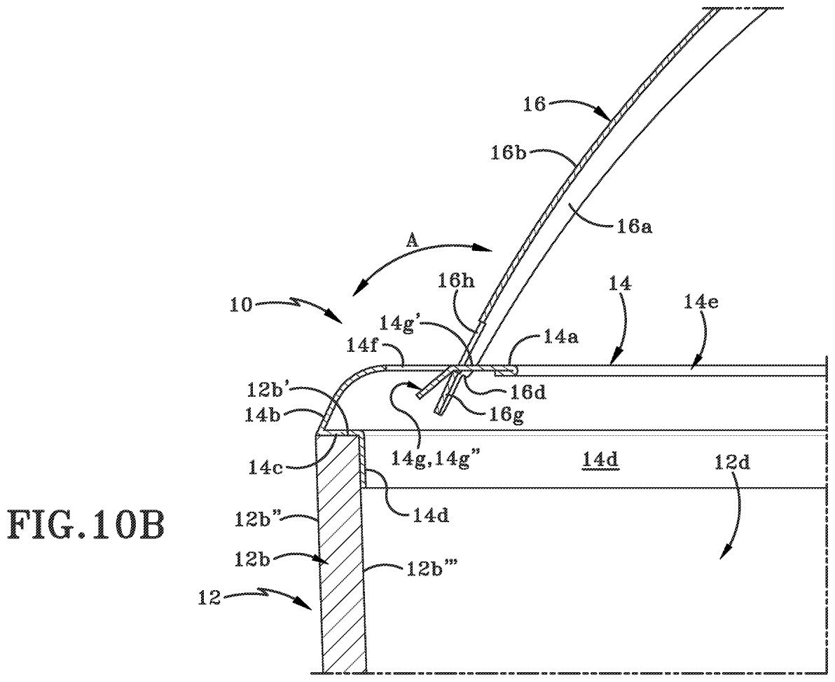

Referring to FIGS. 1-9, there is shown a first embodiment of a splatter guard in accordance with an aspect of the present disclosure, generally indicated at 10. Splatter guard 10 is illustrated as being engaged with a pot or pan 12 that is generally circular in shape when viewed from above. The pot or pan will be referred to herein as “pan 12”. As best seen in FIG. 5, pan 12 includes a bottom wall 12a and an annular side wall 12b that extends upwardly from bottom wall 12a. Side wall 12b terminates in an upper edge 12b′ (FIG. 5) which extends between an exterior surface 12b″ (FIG. 10A) of side wall 12b and an inner surface 12b′″ thereof. Upper edge 12b′ is located a distance vertically above bottom wall 12a. A handle 12c extends outwardly away from an outer surface of side wall 12b. Bottom wall 12a and side wall 12b together bound and define a central interior 12d. Food to be cooked (not shown) is received in this central interior 12d and rests upon bottom wall 12a. Upper edge 12b′ of side wall 12b defines an opening (not numbered) through which the central interior 12d is accessed.

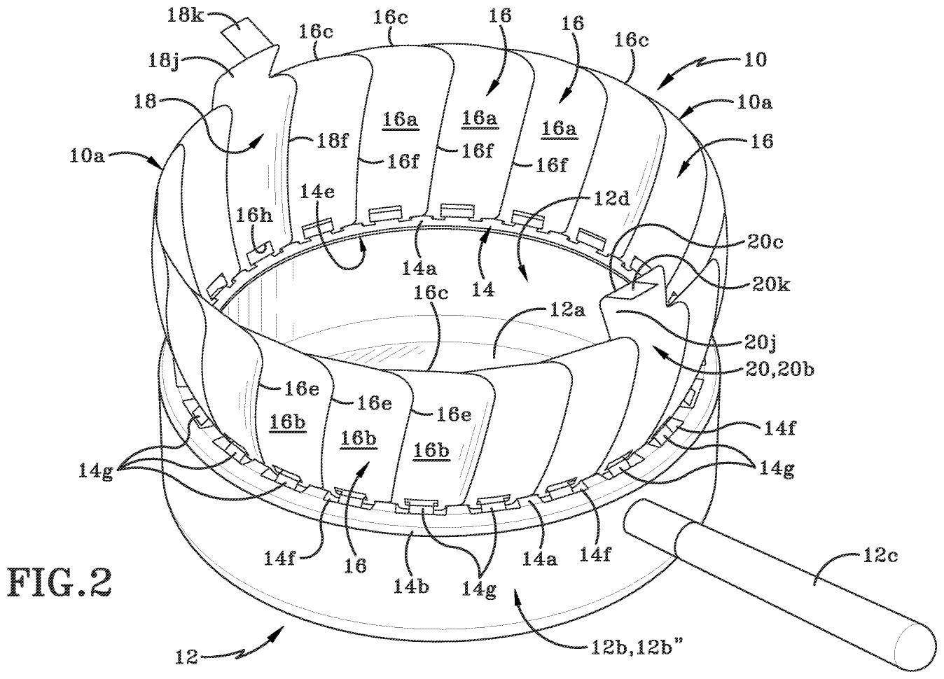

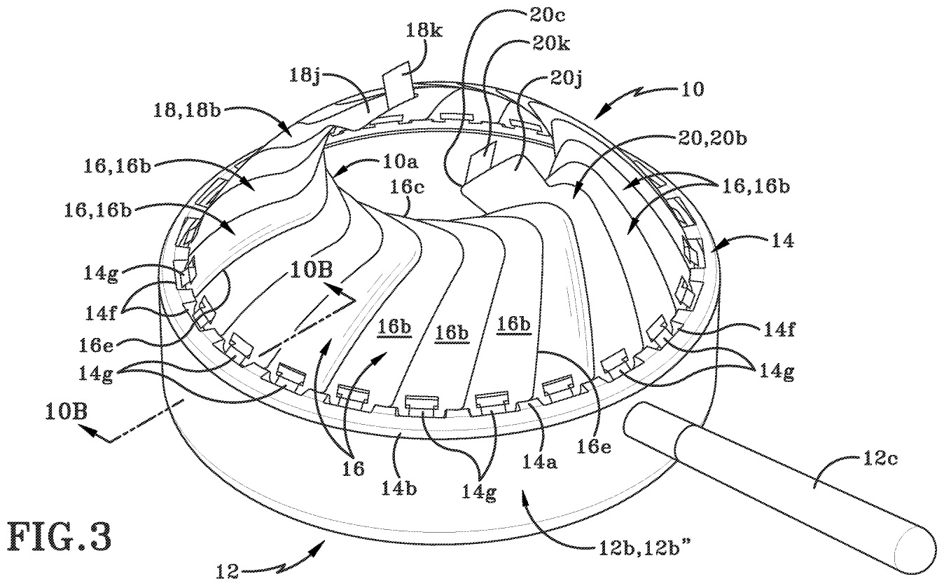

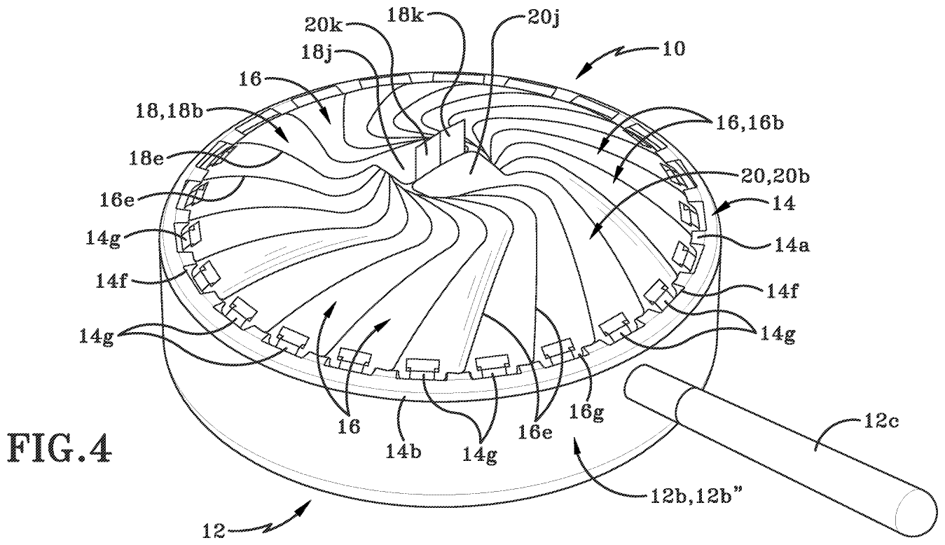

Spatter guard 10 comprises a base 14 and a plurality of petals 16 that is engaged with the base 14. Base 14 is a relatively rigid structure that is capable of supporting the plurality of petals on the pan 12 regardless of whether the splatter guard 10 is in a fully open position (FIG. 1), a partially closed position (FIGS. 2 and 3), and a fully closed position (FIG. 4). The base 14, as will be described hereafter, is configured in such a way that the splatter guard 10 will not accidentally drop into pan 12 and also cannot easily be accidentally knocked laterally off the pan 12.

Two of the plurality of petals engaged with base 14 will be referred to herein as “actuating petals”. These first and second actuating petals are identified by the reference characters 18 and 20, respectively. The first and second actuating petals 18, 20 are arranged opposed to one another amongst the other petals 16. As indicated above, the plurality of petals 16 is movable relative to the base 14 between a first position and a second position. When the plurality of petals 16 is in the first position, the splatter guard 10 is in the fully open position illustrated in FIG. 1. In this first position, the plurality of petals forms a truncated conical skirt which circumscribes the aperture 14e defined by base 14. When splatter guard 10 is in the fully open position, each petal 16, 18, 20 is oriented at an obtuse angle (FIG. 10A) relative to base 14. The truncated conical skirt flares upwardly and outwardly away from the base 14 and allows access to the interior 12d of the pan 12 through the aperture 14e defined by base 14. The shape and angle of the conical skirt relative to the base 14 allows complete access to the cooking surface of the pan 12 in a relatively normal cooking fashion without the cook or chef having to reach into the pan 12 at an awkward angle to manipulate the food while using the splatter guard 10 to guard against splatters.

When the plurality of petals 16 is in the second position, the splatter guard 10 is in the fully closed position illustrated in FIG. 4. In this second position, the plurality of petals 16 forms a convex dome that completely covers an opening to the interior 12d of the pan 12. The petals 16, 18, 20 are each oriented at an acute angle (FIG. 10B) relative to base 14 when splatter guard 10 is in the fully closed position. This will be discussed further hereafter. It should be noted that when splatter guard 10 is in this completely closed position, it is not completely air tight. There will still be gaps that permit some of the steam to escape from within the interior 12d of pan 12. These gaps includes the openings 14f where the petals 16 attach to the base 14, and the overlapping regions of adjacent petals are not air tight but allow some steam to escape therethrough. Splatter guard 10 therefore allows food in pan 12 to continue to fry, for example, instead of being steamed. However, moving splatter guard 10 to the fully closed position helps to close off access to the cooking surface of pan 12 (i.e., to the interior 12d and bottom 12a) and thus allows the temperature within interior 12d to increase and thereby reducing the overall cooking time and energy used for cooking the food.

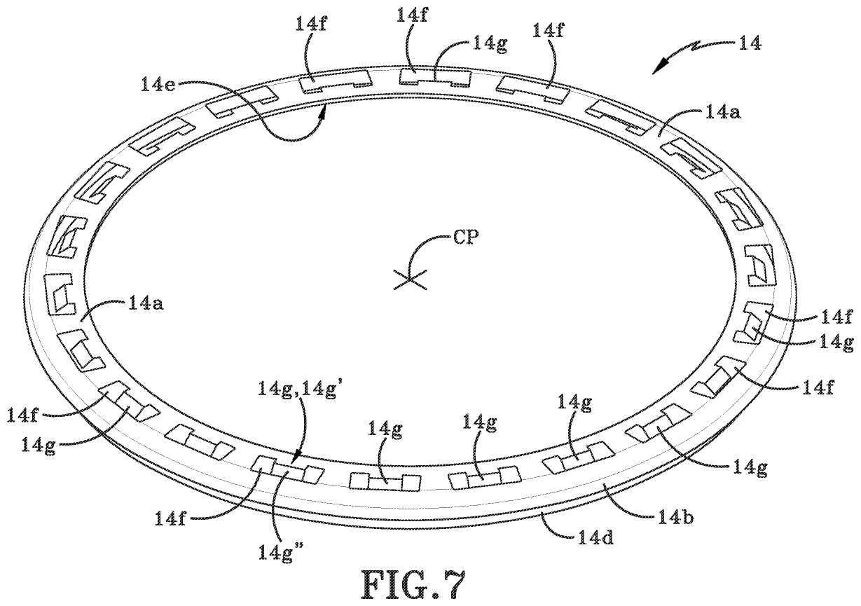

Referring now to FIG. 7 and 10A, base 14 is an annular member that comprises an annular first wall 14a oriented along a plane P-P. An annular second wall 14b curves outwardly and downwardly from an outer circumferential edge of the first wall 14a. An annular third wall 14c (FIG. 10A) extends inwardly from the bottom of the second wall 14b and is arranged generally parallel to the first wall 14a. An annular fourth wall 14d extends downwardly from the inner end of the third wall 14c and is oriented at right angles to third wall 14c. Third and fourth walls 14c, 14d together define an annular L-shaped recess configured to be seated on the upper edge 12b′ of side wall 12b of pan 12, as will be described later herein. As indicated earlier herein, base 14 is configured so that the splatter guard 10 does not drop into interior 12d of the pan 12 and is not easily knocked off the pan 12. In particular, third wall 14c is configured to be complementary in shape and size to the upper edge 12b′ of pan 12 and therefore helps to ensure that splatter guard 10 will not drop into the interior 12d of the pan 12. Fourth wall 14d is substantially complementary in shape and size to an upper portion of the side wall 12b of pan 12 and extends downwardly into the interior 12d for a distance. Fourth wall 14d helps to ensure that splatter guard 10 does not easily become dislodged from upper edge 12b′ and be knocked sideways off the pan 12.

With continued reference to FIG. 7, first wall 14a of base 14 bounds and defines an aperture 14e. Additionally, a plurality of apertures 14f are defined in first wall 14a. Apertures 14f are arranged at regular intervals around the circumference of first wall 14a. Each aperture 14f extends between an upper surface of first wall 14a and a lower surface thereof. Adjacent apertures 14f are separated from each other by a portion of first wall 14a. Each of the apertures 14f is preferably U-shaped when viewed from above and a detent 14g extends between the two legs of the U-shape. FIG. 10A shows that detent 14g includes a first region 14g′ that is integral with and aligned in the same plane P-P as first wall 14a. Detents 14g further includes a second region 14g″ that is integral with first region 14g′ but angles downwardly away from the plane P-P. In particular, second region 14g″ is oriented at an obtuse angle a (i.e., more than 90 degrees), relative to the first wall 14a.

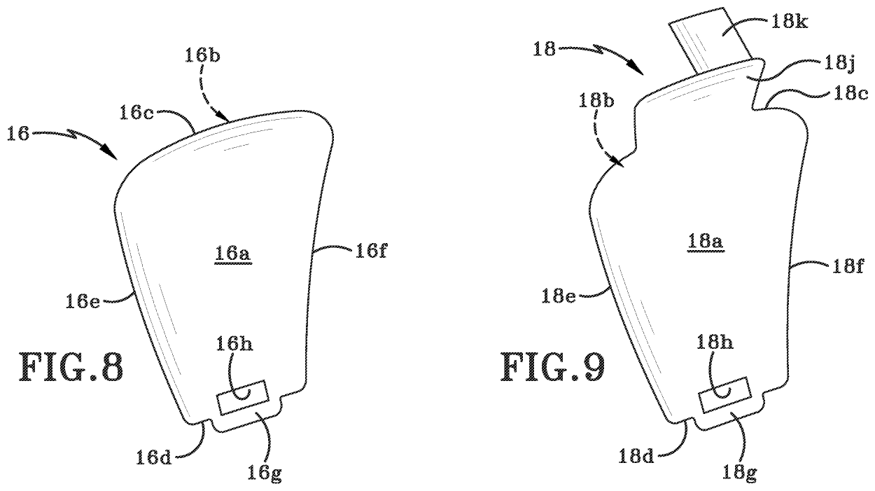

FIG. 8 shows one of the petals 16 that is selectively engaged with base 14. Each petal 16 has an inner surface 16a, an outer surface 16b (FIG. 2), a top 16c, a bottom 16d, a first side 16e, and a second side 16f. Petal 16 is generally rectangular in shape but is of a smaller width proximate bottom 16d than proximate top 16c. (The width is measured in a direction moving from first side 16e to second side 16f.) An extension 16g is integral with the rest of petal 16 and extends downwardly for a distance beyond bottom 16d. Extension 16g is centrally located on bottom 16d and is of a smaller width than bottom 16d. A slot 16h is defined in petal 16 a distance upwardly from bottom 16d and is centrally aligned with extension 16g. Slot 16h extends between the inner surface 16a and outer surface 16b. When petal 16 is engaged with base 14, top 16c of petal 16 is located remote from base 14 and bottom 16d of petal 16 is adjacent base 14 and is actually engaged with base 14.

In one embodiment, if splatter guard 10 is to be engaged with a pan 12 that is approximately twelve inches in diameter, each petal 16 will be of a length of about 5″ (measured between top 16c and bottom 16d; of a width proximate top 16c of about 3.5″ (measured between first side 16e and second side 16f); and of a width proximate bottom 16d of about 2.5″. The width of the extension 16g is about 1″. The width of each aperture 14f into which the extension 16g of a petal 16 is received is approximately about 1¼.

In accordance with an aspect of the present disclosure, each petal 16 is fabricated from a material that is substantially continuous and free of holes or openings which extend between the inner surface 16a and the outer surface 16b other than the slot 16h. As such, each petal 16 forms a substantially continuous surface that is capable of capturing droplets of liquid or small solid particles of food thereon. The substantially continuous inner surface thus prevents liquid droplets and small solid particles of food from moving past the petal 16 to a stove or counter surface beneath the petal (when the splatter guard 10 is in the fully open or partially closed position) or moving past the petal 16 and onto surfaces above the pot or pan 12 (when the splatter guard 10 is in fully closed position). As best seen in FIGS. 10A and 10B, each petal 16 is curved from top 16c to bottom 16d. Petal 16 is also curved from first side 16e through to second side 16f. In particular, front 16a of petal is concavely curved moving from top 16c to bottom 16d and from first side 16e to second side 16f.

When petal 16 is engaged with base 14, extension 16g of petal 16 is inserted into part of one of the U-shaped apertures 14f defined in first wall 14a. Extension 16g is moved downwardly into the associated aperture 14f until second region 14g″ of detent 14g is received through slot 16h of petal 16. Because of the angle at which second region 14g″ of detent 14g is arranged, receiving second region 14g″ through slot 16h locks petal 16 to base 14 and ensures that petals 16 will each move in a fixed plane relative to base 14. Petals 16 are engaged with base 14 in such a way that the inner surface 16a of each petal face will face inwardly towards a center point “CP” (FIG. 7) of base 14. Consequently, when splatter guard 10 is engaged with a pan 12 (as shown in FIG. 1) and the splatter guard 10 is in a fully open position (as in FIG. 1), the inner surfaces 16a of the plurality of petals 16 will form an inclined truncated conical skirt that flares upwardly and outwardly away from the aperture 14e defined by base 14.

It should also be noted that when petals 16 are engaged with base 14, adjacent petals 16 are arranged to partially overlap one another. This overlap is created by the circumferential distance between adjacent apertures 14f of base 14 being slightly smaller than the width of each petal proximate the bottom 16d thereof. Petals 16 are particularly arranged so that the manner in which adjacent petals 16 overlap one another is consistent about the circumference of base 14. In other words, all of the petals 16 overlap one another in a same direction and in a circular pattern such that movement of any one of the petals 16 will result in corresponding movement in the remainder of the petals 16. In the embodiment of splatter guard 10 illustrated in FIG. 1, for example, a portion of a first petal 16A proximate the second side 16f thereof overlaps a portion of the inner surface 16a of the adjacent second petal 16B. The overlap extends beyond the first side (not shown) of the second petal 16B. Similarly, a portion of the second petal 16B proximate the second side 16f thereof overlaps a portion of the inner surface 16a of the adjacent third petal 16C. The overlaps extends beyond the first side (not shown) of the third petal 16C. This pattern of overlap continues around the circumference of base 14. In other instances, it may be that the petals are arranged so that a portion of the first side of each petal will overlap a portion of the front of the adjacent petal. The overlap helps to ensure that if a first petal of the plurality of petals 16 moves inwardly or outwardly relative to the center point “CP” of base 14, all of the other petals 16 will move substantially simultaneously in a similar fashion to the first petal. In other words, movement of one petal will cause all of the petals to move substantially in unison with one another.

It should be noted that when splatter guard 10 is in the fully open position (FIG. 1), adjacent petals 16 overlap one another slightly and relatively loosely. When splatter guard 10 is moved to the fully closed position (FIG. 4), adjacent petals 16 overlap each other to a much greater extent and relatively tightly. The degree of overlap of the plurality of petals and the degree of looseness or tightness afforded by the overlap will gradually change as the splatter guard 10 is moved between the fully open and fully closed positions.

It should further be noted that the arrangement of the petals 16, 18, 20 and base 14 is such that the plurality of petals remain in any orientation relative to the base 14 to which a user may move them without the user having to continue to hold the petals in the desired position. For example, the user may move the plurality of petals to a first partially closed position illustrated in FIG. 2 and the petals will remain in the illustrated orientation without the user having to lock them in place. Similarly, if the plurality of petals is moved to the second partially closed position shown in FIG. 3, the petals will remain in the illustrated configuration without the user having to continue to hold them or lock them in the illustrated orientation. This automatic holding of the petal positions is a result of the concave shape of the petals 16, 18, 20 and the manner in which they engage base 14 and overlap one another.

As indicated earlier herein, splatter guard 10 includes a first actuating petal 18 and a second actuating petal 20. First actuating petal 18 and second actuating petal 20 are substantially identical to one another and therefore only first actuating petal 18 will be described in greater detail herein but it should be understood that the description applies equally to second actuating petal 20.

Actuating petals 18, 20 are substantially identical to petals 16 except that they are of a greater length (measured between top 16c and bottom 16d) than petals 16. The additional length is provided by tabs 18j, 20j, respectively.

It will be understood that while splatter guard 10 is disclosed as including two actuating petals 18, 20, in other embodiments the splatter guard 10 may only include one actuating petal and in yet other embodiments, more than two actuating petals may be provided.

Referring to FIG. 9, first actuating petal 18 has a front surface 18a, a rear surface 18b (FIG. 4), a top 18c, a bottom 18d, a first side 18e, and a second side 18f. Petal 18 is generally rectangular in shape but is of a smaller width proximate bottom 18d than proximate top 18c. An extension 18g is integral with the rest of first actuating petal 18 and extends downwardly for a distance beyond bottom 18d. Extension 18g is centrally located on bottom 18d and is of a smaller width than bottom 18d. A slot 18h is defined in petal 18 a distance upwardly from bottom 18d and is centrally aligned with extension 18g.

First actuating petal 18 differs from all of the petals 16 in that a tab 18j is integral with the rest of first actuating petal 18 and extends upwardly beyond top 18c. Tab 18j is narrower in width than top 18c of first actuating petal 18 but is wider than extension 18g. Tab 18j may also be wider than bottom 18d of first actuating petal 18. First actuating petal 18 is concavely curved from top 18c to bottom 18d. Petal 18 is also concavely curved from first side 18e through to second side 18f.

First actuating petal 18 differs further from all of the petals 16 in that it also includes a flange 18k which extends outwardly from tab 18j moving in a direction away from outer surface 18b thereof. Flange 18k may be oriented at right angles to the outer surface 18b of tab 18j.

When first actuating petal 18 is engaged with base 14, extension 18g is inserted into part of one of the U-shaped apertures 14f defined in first wall 14a. Extension 18g is moved downwardly into the associated aperture 14f until second region 14g″ of detent 14g is received through slot 18h of petal 18. Because of the angle at which second region 14g″ of detent 14g is arranged, receiving second region 14g″ through slot 18h locks first actuating petal 18 to base 14. First actuating petal 18 and second actuating petal 20 are engaged with base 14 in such a way that the front of these two actuating petals will face inwardly towards the center point “CP” (FIG. 7) of base 14 in a similar manner to the inner surfaces 16a of the petals 16.

As indicated above, second actuating petal 20 is identical to first actuating petal 18 but is engaged with base 14 in such a way that first actuating petal 18 and second actuating petal 20 are diametrically opposite one another and arranged as mirror images of one another. Second actuating petal 20 includes a tab 20j and an associated flange 20k that are substantially identical to tab 18j and flange 18k.

Splatter guard 10 is used in the following manner. The user will select a pot or pan 12 within which they wish to cook food and will select a splatter guard 10 having a base 14 that is of a substantially similar diameter to a diameter of the upper edge 12b′ of the pot or pan 12. So, for example, if the pot or pan 12 has a twelve inch diameter then the splatter guard 10 that is selected for use with that particular pot or pan 12 will have a base that is twelve inches in diameter. If the pot or pan 12 has a ten inch diameter then the splatter guard 10 for use therewith will have a base that is ten inches in diameter.

Once the correct diameter splatter guard 10 has been selected, the user will engage the splatter guard 10 with the pot or pan 12. Referring to FIGS. 10A and 10B, base 14 of splatter guard 10 is engaged with side wall 12b of pot or pan 12 by placing the third wall 14c in abutting contact with upper edge 12b′ of side wall 12b and resting the fourth wall 14d of the base 14 in abutting contact with the inner surface 12b′″ of side wall 12b of the pot or pan 12. In other words, the upper edge 12b′ is received in the L-shaped recess defined by the third and fourth walls 14c, 14d of base 14. It should be noted that splatter guard 10 may be engaged with pot or pan 12 when in a fully open position (FIG. 1), a partially closed position (FIGS. 2 or 3), or a fully closed position (FIG. 4). It should further be noted that splatter guard 10 may be engaged with pot or pan 12 before food is put into pot or pan 12 or after the food has been put into the pot or pan 12, and either before or after cooking of the food has been initiated.

Spatter guard 10, when in the fully open position (FIG. 1) has an opening that is bounded and defined by an outer edge 10a of the conical skirt of petals 16. The outer edge 10a is formed by the tops 16c, 18c, 20c of the petals 16 and actuating petals 18, 20. The opening defined by the outer edge 10a is of a diameter that may be adjusted by manipulating the position of the petals 16, 18, 20 relative to base 14. If the user wishes to change the diameter of the opening defined by the outer edge 10a, then he or she can push on one or both flanges 18k, 20k of the first and second actuating petals 18, 20 with the thumbs or fingers of one or both hands, depending on the distance between tabs 18j, 20j. The pushing force is applied in a direction that moves the tabs 18j, 20j towards one another and towards the center point “CP” of the base 14. Alternatively, the pushing force may be applied to the outer surface 16b of any of the petals 16, or to the outer surface 18b of the first actuating petal 18, or to the outer surface 20b (FIG. 2) of the second actuating petal 18, 20. The pushing force is continued until the size of the opening defined by the outer edge 10a of the conical skirt is of the size desired by the user. For example, the pushing force is applied until the opening is at a first partially closed position (shown in FIG. 2) or a second partially closed position (shown in FIG. 3). The pushing force may be continued until the opening defined by the outer edge 10a is substantially completely closed (shown in FIG. 4). The diameter of the opening in splatter guard 10 is of a maximum size when petals 16, 18, 20 are moved to the fully open position (FIG. 1) and is of a minimum size when petals 16, 18, 20 are moved to the fully closed position (FIG. 4).

The flanges 18k, 20k may be provided on the associated tabs 18j, 20j so that their fronts will abut each other when the splatter cover 10 is moved to the completely closed position. In this instance, the flanges 18k, 20k may, for instance, be centrally located on the associated tab 18j, 20j. Alternatively, the flanges 18k, 20k may be offset from one another. Then when the splatter cover 10 is moved to the completed closed position, the flanges 18k, 20k will move into alignment with one another. This latter arrangement is illustrated in FIG. 4.

The user is able to move the splatter guard 10 between a fully open position (FIG. 1) to a fully closed position (FIG. 4) depending on their preference. If the user needs access to the food in the pot or pan to flip something that is frying or to stir a sauce, for example, the splatter guard 10 may be moved to the fully open position. This can be accomplished by the user grasping flanges 18k, 20k and pulling them outwardly away from each other in a direction moving away from the center point “CP” of base 14. As the pulling force is applied to the flanges 18k, 20k, the first and second actuating petals 18, 20 are moved outwardly away from each other. As this occurs, the remaining petals 16 are simultaneously caused to fold outwardly away from each other and, in so doing, form a truncated conical skirt. The truncated conical skirt bounds and defines a conical space which is in fluid communication with the aperture 14e defined by base 14 and with the opening to the interior 12d of the pot or pan 12. When the splatter guard 10 is in a fully open or partially open position, the user is able to insert a flipper or spoon or other cooking implement into the pot or pan and flip or stir the food on the cooking surface, i.e., bottom wall 12a. The user is also able to season the food, add other ingredients through the opening bounded by the truncated conical skirt.

As the food cooks, hot oil or boiling liquid creates fine droplets which are entrained in the hot air rising from the pot or pan 12. Small particles of food may also be entrained in the hot air rising from the pot or pan 12. The hot air rises through the opening to the pot or pan 12, through the aperture 14e defined by the base 14 and out of an opening 10a defined by the truncated conical skirt. At least some of the entrained liquid droplets and small food particles will start to drop back downwardly toward the stove surfaces surrounding the pan 12. These droplets and small food particles will come to rest on the conical skirt created by the petals 16, 18, 20. The conical skirt will thereby tend to prevent these droplets and food particles from coming into contact with the stove or other surfaces.

When the splatter guard 10 is moved to the completely closed position as in FIG. 4, the splatter guard 10 effectively becomes a lid with a handle (formed by flanges 18k, 20k), and will substantially keep the heat close to the cooking food and will also substantially prevent droplets of hot oil or liquid from moving past the petals 16, 18, 20. The user may periodically manipulate the flanges 18k, 20k to allow the user to stir or flip the food and/or to release some of the heat that is trapped between the closed splatter guard 10 and the pot or pan 12.

The splatter guard 10 in accordance with the present disclosure therefore offers the best features of prior art devices in that it can be moved to a first open position where it forms a conical skirt that extends upwardly and outwardly from the top of the pot or pan 12 and allows the user access to the cooking food or allows heat to escape from the pot or pan12. The splatter guard 10 may be moved to a first or second partially closed position to limit the size of the opening through which hot air and entrained droplets may escape. It will be understood in this first or second partially closed position the splatter guard 10 forms an inverted truncated conical skirt that offers the advantages of some of the prior art devices. The splatter guard 10 may further be moved to the fully closed position where it acts as a lid and substantially prevents heat and entrained droplets from escaping from the pot or pan 12. The possible movement of the petals 16, 18, 20 and thereby of the conical skirt formed thereby is indicated in FIG. 10B by the arrow “A”.

When it is desired to stop using the splatter guard 10, the device is simply lifted upwardly and thereby moves out of engagement with the pot or pan's side wall. Splatter guard 10 preferably will be fabricated from a material that allows the device to be quickly and easily washed, and may even be suitable for placement into a dishwasher. Suitable materials for fabrication of splatter guard 10 include but are not limited to aluminum, stainless steel, and a food grade silicone, or any other food-safe, heat resistant material.

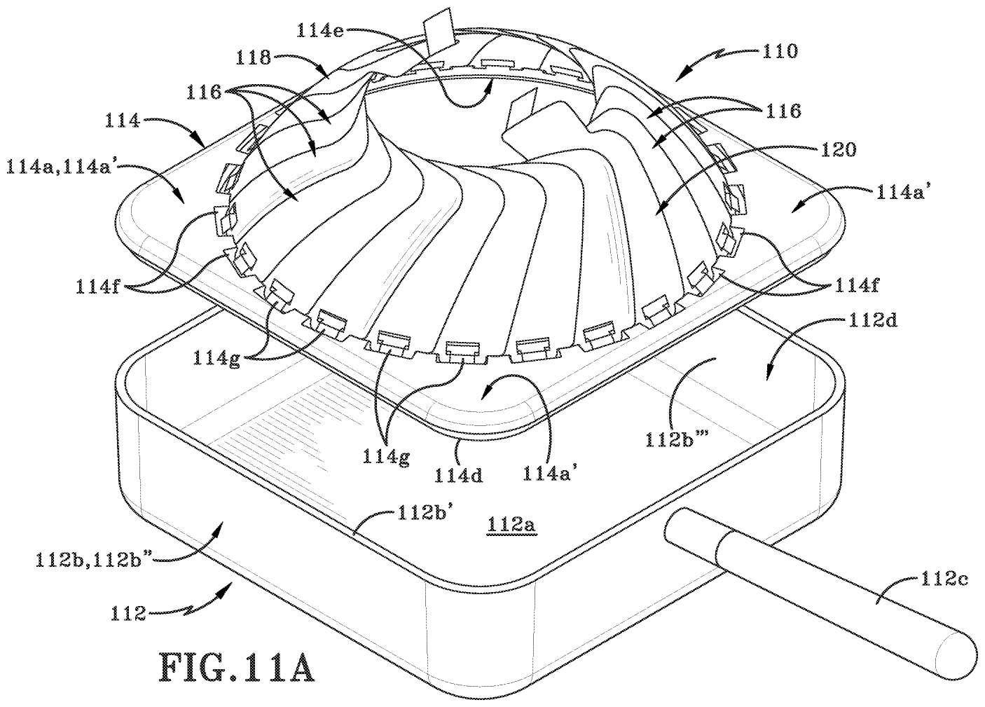

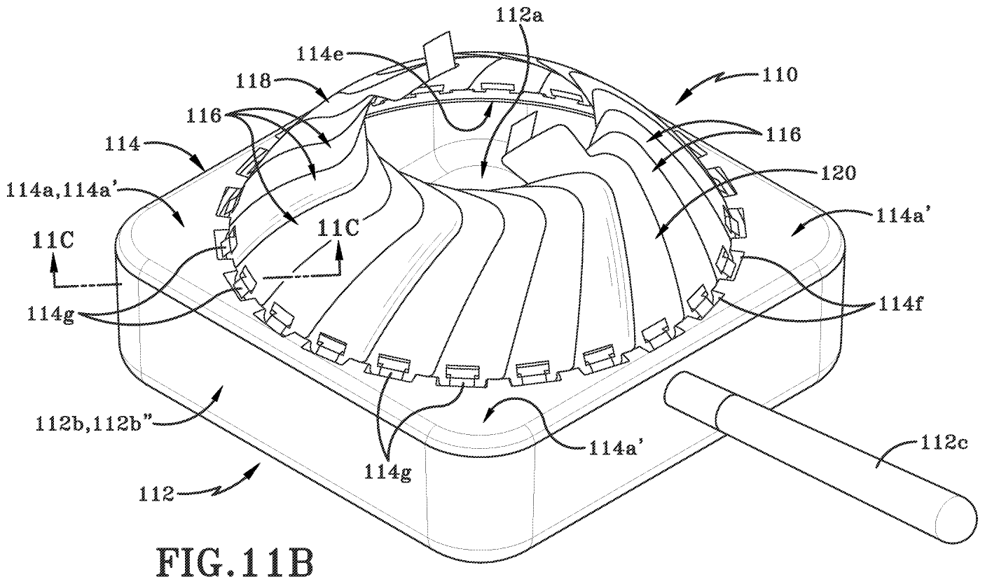

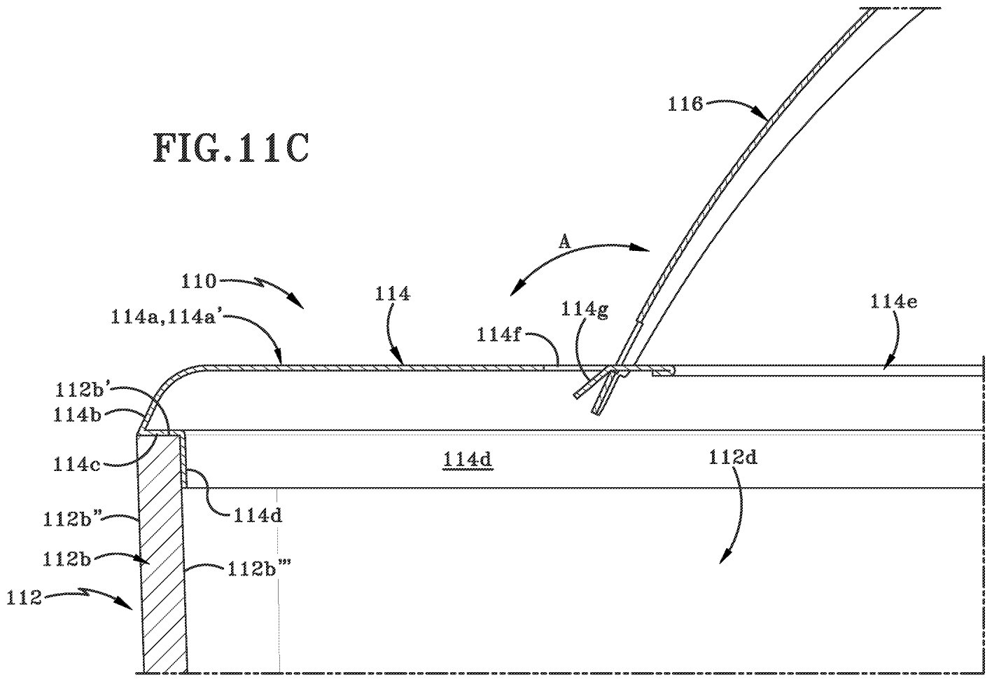

Turning now to FIGS. 11A, 11B, and 11C there is illustrated a second embodiment of a splatter guard in accordance with an aspect of the present disclosure, generally indicated at 110. Splatter guard 110 is specially configured to be engaged with a square pot or pan, generally indicated by the reference number 112 (hereafter referred to as “pan 112”). Pan 112 has a bottom wall 112a, a square side wall 112b that extends upwardly from bottom wall 112a, and a handle 112c. Bottom wall 112a and side wall 112b bound and define an interior cavity 112d into which food or liquid may be placed. Side wall 112b has an upper edge 112b′ and further includes an outer surface 112b″ and an inner surface 112b′″.

Splatter guard 110 is substantially identical to splatter guard 10 in every respect except for the specific features disclosed hereafter. Splatter guard 10 includes a base 114, a plurality of petals 116, a first actuating petal 118, and a second actuating petal 120. Splatter guard 110 differs from splatter guard 10 in the configuration of the base 114. Unlike base 14, base 114 is not configured to be engaged with a circularly shaped upper edge 12b′ of a pan 12 but is instead configured to be engaged with a square-shaped upper edge 112b′ of pan 112. Base 114 includes a first wall 114a, a second wall 114b that curves outwardly and downwardly away from the outer perimeter of first wall 114a, a third wall 114c that extends inwardly from the bottom of the second wall 114b, and a fourth wall 114d that angles downwardly from the inner end of the third wall 114c. The fourth wall 114d is oriented generally at right angles to the third wall such that an L-shaped recess is defined by the third and fourth walls 114c, 114d. The upper edge 112b′ of the pan 112 is received in this L-shaped recess such that the third wall 114c is seated on the upper edge 112b′ of the side wall 112b, and the fourth wall 114d abuts the inner surface 112b′″ of the side wall 112b. First wall 114a bounds and defines an aperture 114e about which the plurality of petals 116 are arranged.

Similar to base 14, base 114, defines a plurality of apertures 114f therein that are of a substantially configuration as the apertures 14f. Apertures 114f, like apertures 14f are arranged to form an annular ring of apertures. The apertures 114f are spaced at regular intervals from each other and adjacent apertures 114f are separated from one another by a portion of the first wall 114a of the base 114. Detents 114g extend into apertures 114f and are of substantially identical configuration to the detents 14g. Petals 116, 118, 120 are engaged with base 114 in an identical manner to the way petals 16, 18, 20 are engaged with base 14. The petals 116, 118, 120 are able to be moved between a fully open position, a partially closed position, and a fully closed position in an identical manner to how petals 16, 18, 20 are movable. It will therefore be understood that the base 114 is different from base 14 only in that it has been specially configured to engage the square pan 112 by including substantially square second, third, and fourth walls 114b, 114c, 114d and providing four generally triangular corner regions 114a′ as part of first wall 114a. The corner regions 114a′ extend outwardly beyond the annular ring of apertures 114f to aid in forming the square shape of base 14.

Spatter guard 114 functions in substantially the identical manner to splatter guard 14 and the method of use thereof will therefore not be described in any further detail herein.

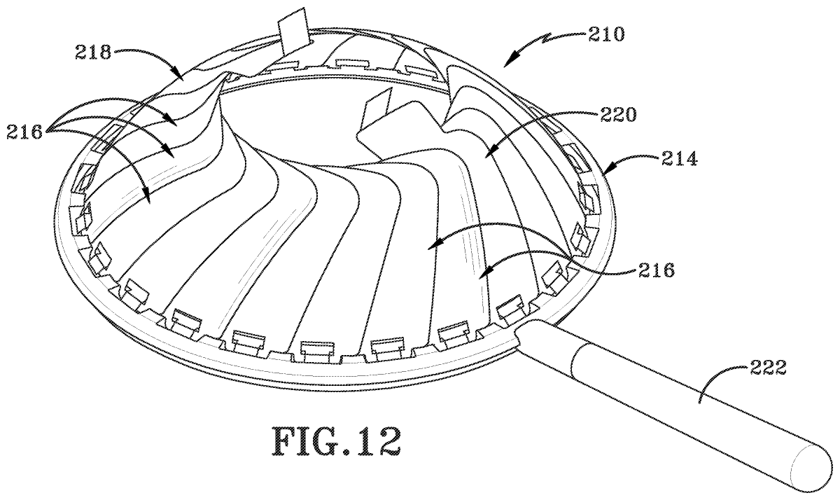

Referring now to FIG. 12, there is shown a third embodiment of a splatter guard in accordance with an aspect of the present disclosure, generally indicated at 210. Splatter guard 210 is configured for engagement with a circular pot or pan (similar to pan 12). Splatter guard 210 includes a base 214, petals 216, a first actuating petal 218, and a second actuating petal 220. Base 214 is substantially identical to base 14 except that a handle 222 is integrally formed with base 214 and extends radially outwardly therefrom. Handle 222 makes it easier for a user to lower the splatter guard 210 into engagement with the pan prior to cooking and to lift a hot splatter guard 210 off a hot pan. In all other aspects, splatter guard 210 is identical in structure and function to splatter guard 10. In other words, petals 216 are identical in structure and function to petals 16, first actuating petal 218 is identical in structure and function to first actuating petal 18, and second actuating petal 220 is identical in structure and function to second actuating petal 20.

Although not illustrated herein, it will be understood that splatter guard 110 may be provided with a handle similar to handle 222 provided on splatter guard 210.

As is evident from the above description, when the splatter guard 10 is moved between the fully open position and the fully closed position and back to the fully open position, each petal 16, 18, 20 of the plurality of petals moves between an obtuse angle relative to the base 14 to an acute angle relative to the base, and then back to an obtuse angle relative to the base. Obviously, at some point each of the petals 16, 18, 20 will be oriented generally at right angles to the base 14, thereby forming a generally vertical skirt around the aperture 14e. The skirt is only generally vertical because of the concave curvature of each of the petals 16, 18, 20.

While the petals 16 have been disclosed herein as being fabricated from substantially continuous materials, in other embodiments, the petals may be fabricated from a mesh that has relatively small openings which will effectively block a majority of small liquid droplets and food particles exiting the pot or pan.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A splatter guard comprising:
a base adapted to engage a side wall of a pot or pan;
an aperture defined by the base, said aperture being adapted to align with an opening to an interior of the pot or pan; and
a plurality of petals operatively engaged with the base;
wherein each petal of the plurality of petals is pivotable relative to the base;
wherein the plurality of petals is selectively movable between a first position and a second position; and, when in the first position, the plurality of petals allows access to the interior of the pot or pan through the aperture defined by the base; and, when in the second position, the plurality of petals prevents access to the interior of the pot or pan through the aperture.

2. The splatter guard according to claim 1, wherein the plurality of petals is arranged in an annular ring about the aperture defined by the base.

3. The spatter guard according to claim 2, wherein adjacent petals in the annular ring partially overlap one another; and wherein the plurality of petals moves substantially simultaneously when moving between the first position and the second position.

4. The splatter guard according to claim 1, wherein each petal of the plurality of petals is substantially continuous and free of openings or holes that extend between an inner surface and an outer surface of the petal.

5. The splatter guard according to claim 1, wherein each petal of the plurality of petals has an inner surface and an opposed outer surface, and wherein the inner surfaces of all petals in the plurality of petals circumscribes the aperture defined by the base.

6. The splatter guard according to claim 1, wherein the plurality of petals forms a truncated conical skirt when in the first position, and the truncated conical skirt circumscribes the aperture and flares upwardly and outwardly away from the base.

7. The splatter guard according to claim 1, wherein the plurality of petals forms a convex dome when in the second position.

8. The splatter guard according to claim 1, further comprising an actuating petal provided as one of the plurality of petals, wherein the actuating petal includes a flange that extends outwardly from an outer surface of the petal.

9. The splatter guard according to claim 8, wherein the flange is arranged at an angle to the outer surface of the petal.

10. The splatter guard according to claim 8, wherein each petal of the plurality of petals includes a top and a bottom, wherein the bottom is operatively engaged with the base and the top is remote from the base; wherein the plurality of petals forms a truncated conical skirt that circumscribes the aperture defined by the base; and wherein the tops of all of the petals in the plurality of petals together form a circumferential outer edge of the truncated conical skirt.

11. The splatter guard according to claim 10, wherein the actuating petal includes a tab that extends outwardly for a distance beyond the circumferential outer edge of the truncated conical skirt.

12. The splatter guard according to claim 10, wherein the flange is provided on the tab.

13. The splatter guard according to claim 8, further comprising a second actuating petal provided in the plurality of petals, wherein the second actuating petal is provided opposite the actuating petal, and the second actuating petal is arranged in plurality of petals as a mirror image of the actuating petal.

14. The splatter guard according to claim 1, wherein the plurality of petals are arranged in an annular ring and the base is substantially square when viewed from above and extends for a distance outwardly beyond the annular ring of the plurality of petals.

15. The splatter guard according to claim 1, further comprising a handle extending radially outwardly from the base.

16. A method of preventing liquid droplets and small particles of food from settling on surfaces surrounding a pot or pan in which foods is cooking, said method comprising:
providing a splatter guard including a base and a plurality of petals circumscribing an aperture defined by the base;
engaging the base of the splatter guard with a side wall of the pot or pan;
aligning the aperture defined by the base with an opening to an interior of the pot or pan;
moving the plurality of petals to a first position when access to the interior of the pot or pan is desired; and
moving the plurality of petals to a second position when access to the interior of the pot or pan is not desired.

17. The method according to claim 16, further comprising:
creating a truncated conical skirt with the plurality of petals when moved to the first position; wherein the truncated conical skirt flares upwardly and outwardly away from the base; and
capturing liquid droplets and small particles of food entrained in hot air exiting the interior of the pot or pan on the truncated conical skirt; and
preventing the captured liquid droplets and small particles of food from contacting a surface beneath the conical skirt.

18. The method according to claim 16, further comprising:
creating a convex dome over the aperture defined by the base with the plurality of petals when moved to the second position; and
preventing liquid droplets and small particles of food entrained in hot air in the interior of the pot or pan from moving past the convex dome.

19. The method according to claim 16, further comprising:
providing at least one actuating petal amongst the plurality of petals; and
moving the plurality of petals between the first position and the second position by manipulating the at least one actuating petal.

20. The method according to claim 16, further comprising:
providing a handle on the base; and
manipulating the splatter guard by way of the handle.
